(19) United States
(12) Patent Application Publication
(10) Pub. No.: US 2013/0061722 A1
(43) Pub. Date: Mar. 14, 2013

(54) Two Handle Socket Wrench System

(71) Applicant: Todd Robert Leininger, Pleasant Hill, CA (US)

(72) Inventor: Todd Robert Leininger, Pleasant Hill, CA (US)

(21) Appl. No.: 13/228,738

(22) Filed: Sep. 9, 2011

(51) Int. Cl. B25B 13/46; B25B 23/16

(52) U.S. Cl. 81/63.2

(57) ABSTRACT

A dual handle socket wrench system provides torque generated by two-handed operation. Bolts and other fasteners are removed with greater ease as a wrench operator may use two hands to turn a fastener.

### BACKGROUND OF THE INVENTION

(1) Field of the Invention

The invention generally relates hand tools used for turning fasteners. More particular, the invention relates to a double ratchet system with a center drive.

(2) Description of the Related Art

In the known related art, socket wrench systems have an end drive or a socket piece located at the end of a handle. While such a configuration does allow for two hands to be placed close together, the torque generated is sometimes inadequate for rusted on bolts or other fasteners. Thus, there is a need in the art for means and methods of allowing an operator greater torque with a hand wrench system

### BRIEF SUMMARY OF THE INVENTION

The present invention overcomes shortfalls in the related art by presenting an unobvious and unique combination, configuration and use of components to create a two handled socket wrench system allowing an operator a relatively wide two hand grip distance. The disclosed two handled system allows for greater leverage and torque as compared to the known prior art single handle socket wrench systems. The disclosed system allows for use of an operator's torso strength as an operator may take a wide grip upon dual handles and force rotation around a center socket.

The present invention has achieved unexpected results in removing rusted, welded or otherwise difficult to remove fasteners. The combination of a two handled system with a center socket encourages operators to use their entire body and body strength to rotate a stubborn fastener. Operators using the disclosed system are less prone to injury as torque is generated from an operator's core as opposed to one bicep muscle when using a wrench of the known prior art.

Embodiments of the disclosed invention overcome shortfalls in the prior art by the supply of two or more non-removable handles. During use, the handles will not become separated and allow an operator to focus on the task of fastener removal or fastener tightening. Embodiments of the disclosed invention are especially useful for tapping, a task requiring high amounts of torque. A disclosed assembly includes the feature and use of a reversible drive lever, allowing the direction of applied torque to be reversed without removing the tool from a fastener.

### BRIEF DESCRIPTION OF THE DRAWINGS

FIG. 1 is a perspective view of one contemplated embodiment of the invention.

FIG. 2 is a perspective view of one contemplated embodiment of the invention.

FIG. 3 is a perspective view of one contemplated embodiment of the invention.

FIG. 4 is a perspective view of one contemplated embodiment of the invention.

FIG. 5 is a back side perspective view of one contemplated embodiment of the invention.

FIG. 6 is a back side perspective view of one contemplated embodiment of the invention.

FIG. 7 is a back side perspective view of one contemplated embodiment of the invention.

FIG. 8 is a back side perspective view of one contemplated embodiment of the invention.

FIG. 9 is a perspective view of one embodiment of the invention with an exposed center cavity.

FIG. 10 is a housing cover

FIG. 11 is a socket head

FIG. 12 is a pawl

FIG. 13 shows a shifter, spring and shifter spacer

FIG. 14 is a selector

FIG. 15 is a back perspective view of one embodiment of the invention

FIG. 16 shows a housing cover and two housing cover screws

FIG. 17 shows a socket head

FIG. 18 shows a pawl

FIG. 19 shows a shifter, shifter spacer and shifter spacer spring

FIG. 20 shows a shifter and shifter spacer installed within the small void of a wrench

FIG. 21 shows a housing cover and two housing cover screws

FIG. 22 shows a socket head

FIG. 23 shows a pawl and shifter spacer spring

FIG. 24 shows a shifter spacer spring inserted into a small void within a disclosed wrench system

FIG. 25 shows a housing cover and two housing cover screws

FIG. 26 shows a socket head

FIG. 27 shows a pawl

FIG. 28 shows a pawl installed next to an installed shifter

FIG. 29 shows a housing cover and two housing cover screws

FIG. 30 shows a socket head

FIG. 31 shows a socket head installed into the large void of a disclosed wrench

FIG. 32 shows a housing cover and two housing cover screws

FIG. 33 shows a back side of a disclosed wrench system with a housing cover installed.

### REFERENCE NUMERALS IN THE DRAWINGS

100 an embodiment of the invention in general
200 a handle
300 housing or center housing
301 large void within housing 300
302 small void within housing 300
303 back side of housing
400 housing cover
401 housing cover screw
402 socket head
403 pawl
404 shifter
405 shifter spacer
406 shifter spacer spring
407 selector

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

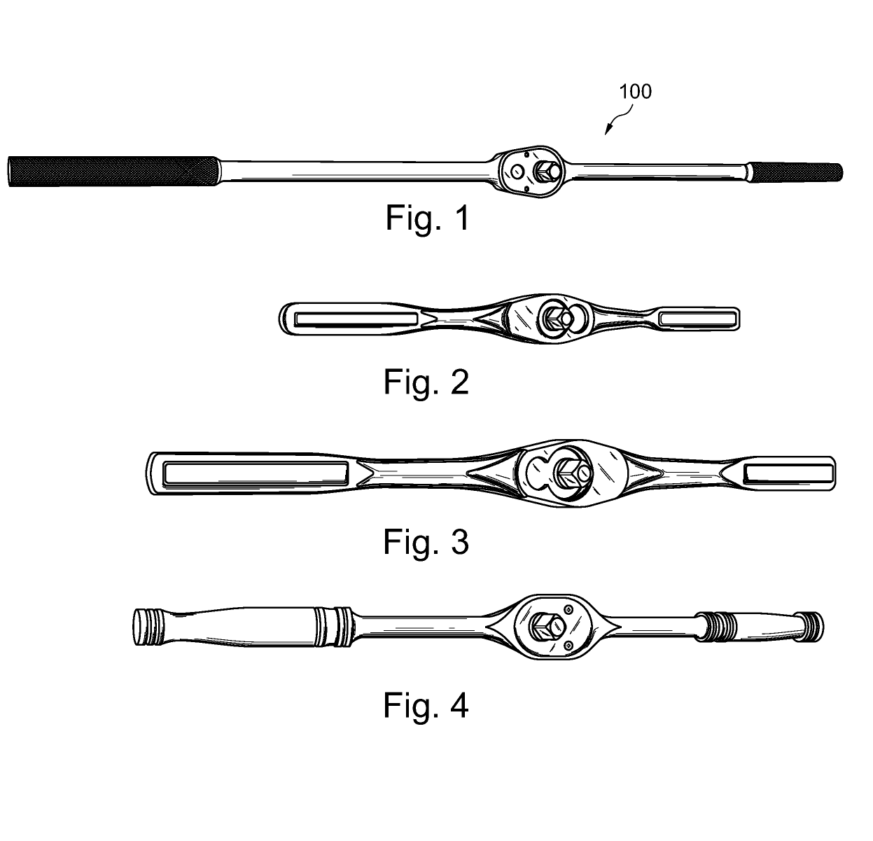

FIG. 1 to FIG. 4 show four contemplated embodiments of the invention 100 in general.

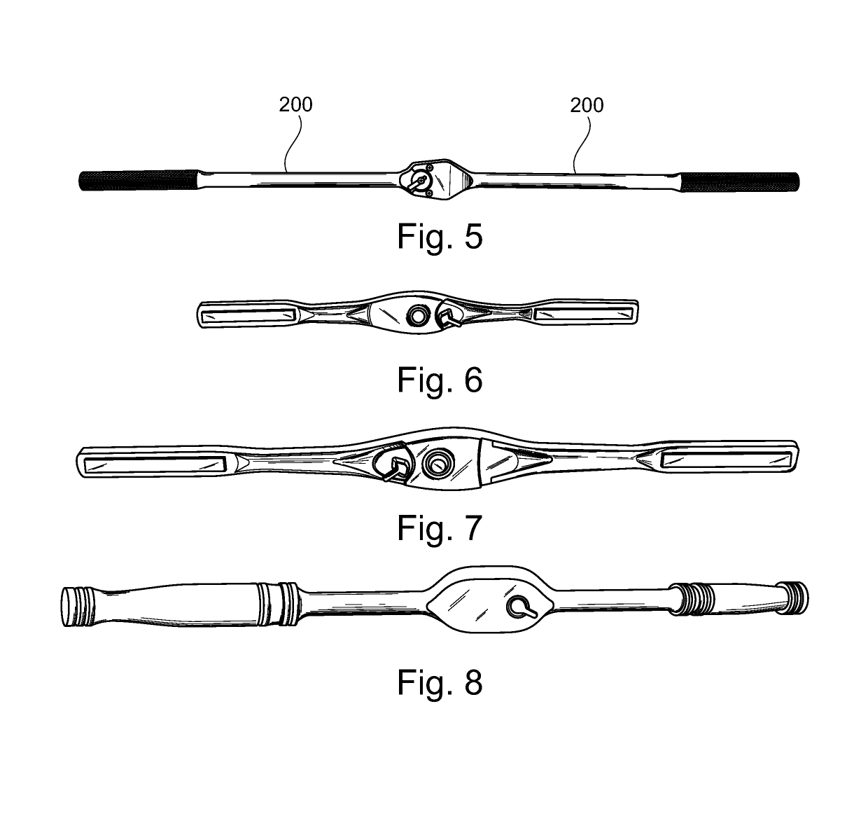

FIG. 5 to FIG. 9 show the backsides of four contemplated embodiments of the invention. FIG. 5 shows two handles 200 or handle sections on either side of a socket head area.

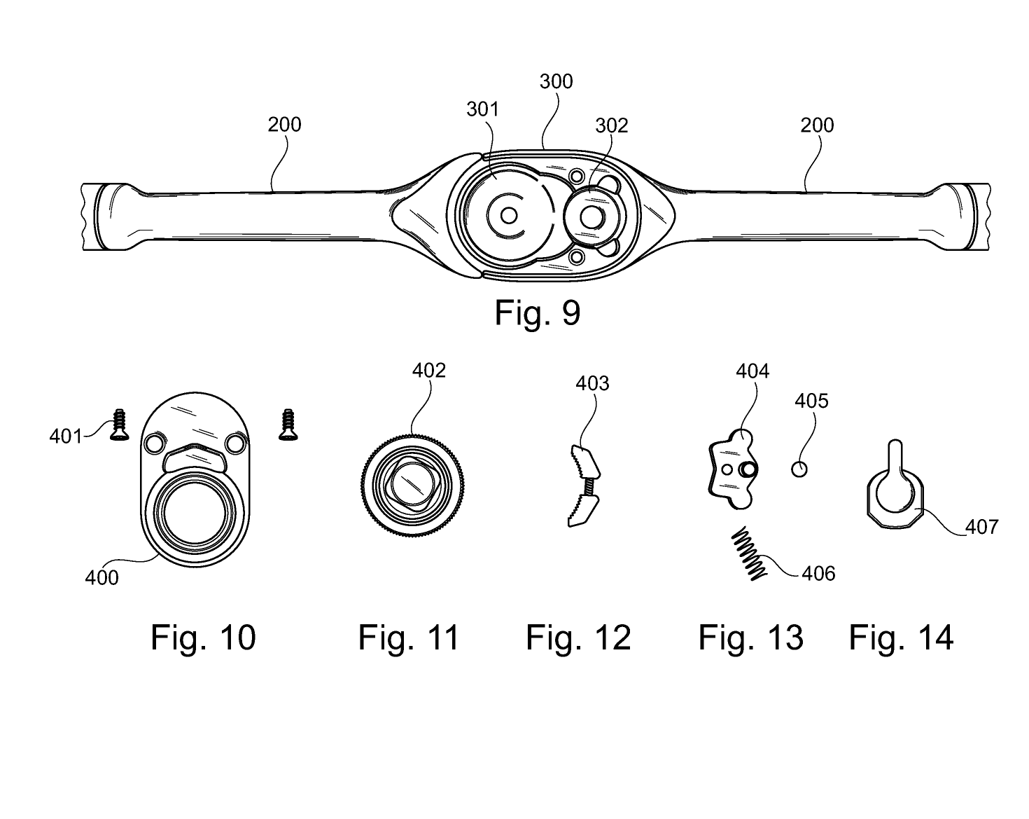

FIG. 9 presents two handles 200 placed on either side of a center housing 300. Shown on the left hand side of the center housing 300 is a relatively large void 301 adjacent to a relatively small void 302. The large void 301 is sometimes used to contain a socket head 402 while the small void 302 sometimes shifter 404, shifter spacer 405 and a shifter spacer spring. A pawl 403 sometimes sits between an installed socket head 402 and installed shifter.

A housing cover 400 sometimes covers the center housing 300. Two or more handles 200 are found on either side of the center housing.

The selector 407 of FIG. 14 is sometimes installed upon the back side of the housing and is used to control the direction of rotation of the socket head.

FIG. 10 shows a housing cover 400 with two screws 401. FIG. 11 presents a plan view of a socket head 402. The socket head may accept a variety of sockets or other implements used to secure fasteners.

FIG. 12 presents a pawl 403 or claw which is sometimes used to control the direction of torque produced by a socket head. The pawl comprises two sides, and one side of the other is forced upon the socket head by the position of the shifter. The position of the shifter is set by movement of the selector 407.

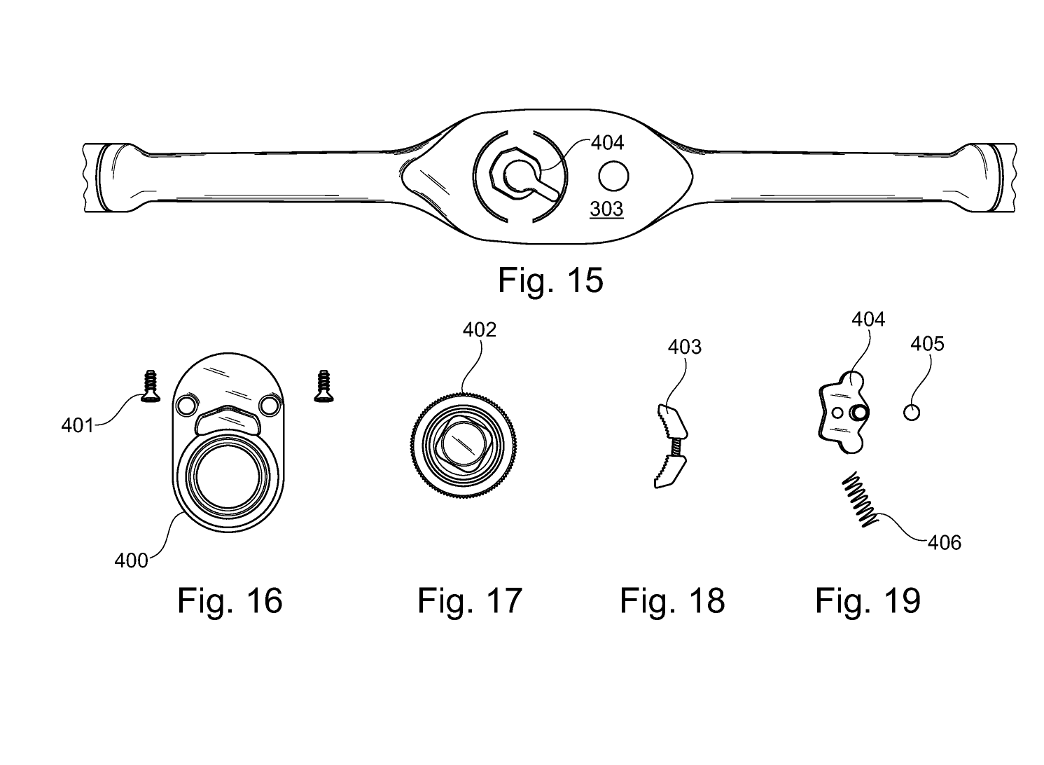

FIG. 15 presents a back side 303 of a housing. A selector 407 has been installed into the backside of the housing. An operator may move the selector 407 to cause the socket head torque in either a clockwise or counter-clockwise direction. In the non-torque direction the socket head moves with ease to allow the handles to be placed in position for a torque motion.

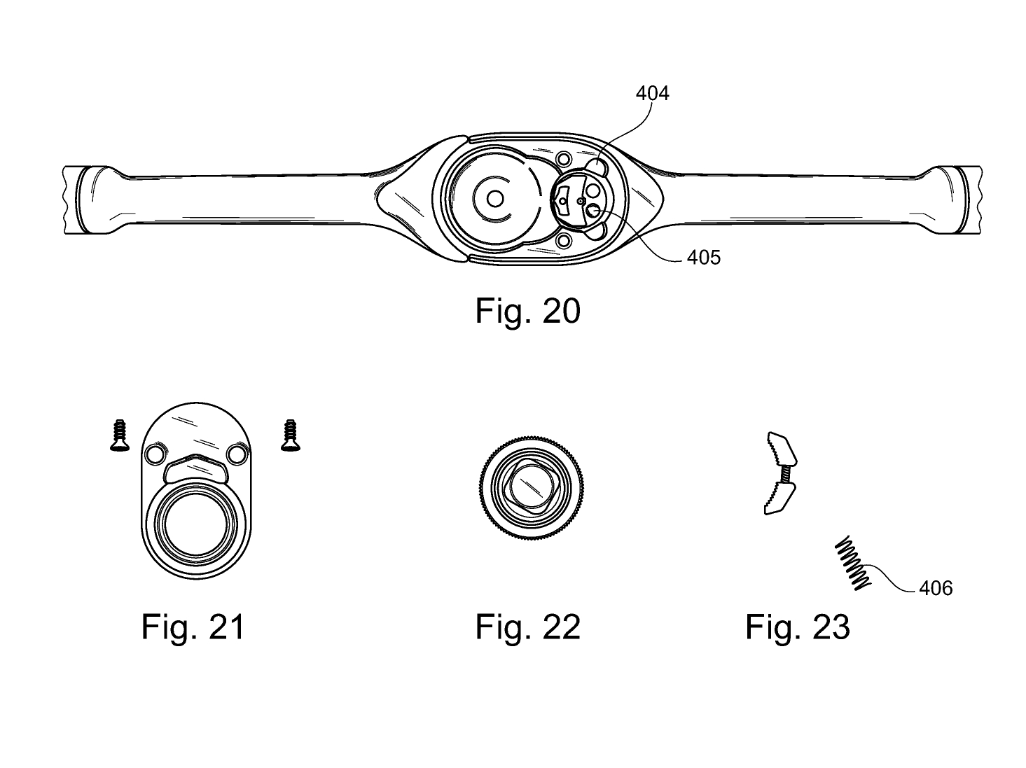

FIG. 20 shows a shifter 404 and shifter spacer 405 placed in position within a small void 302 of a center housing 300.

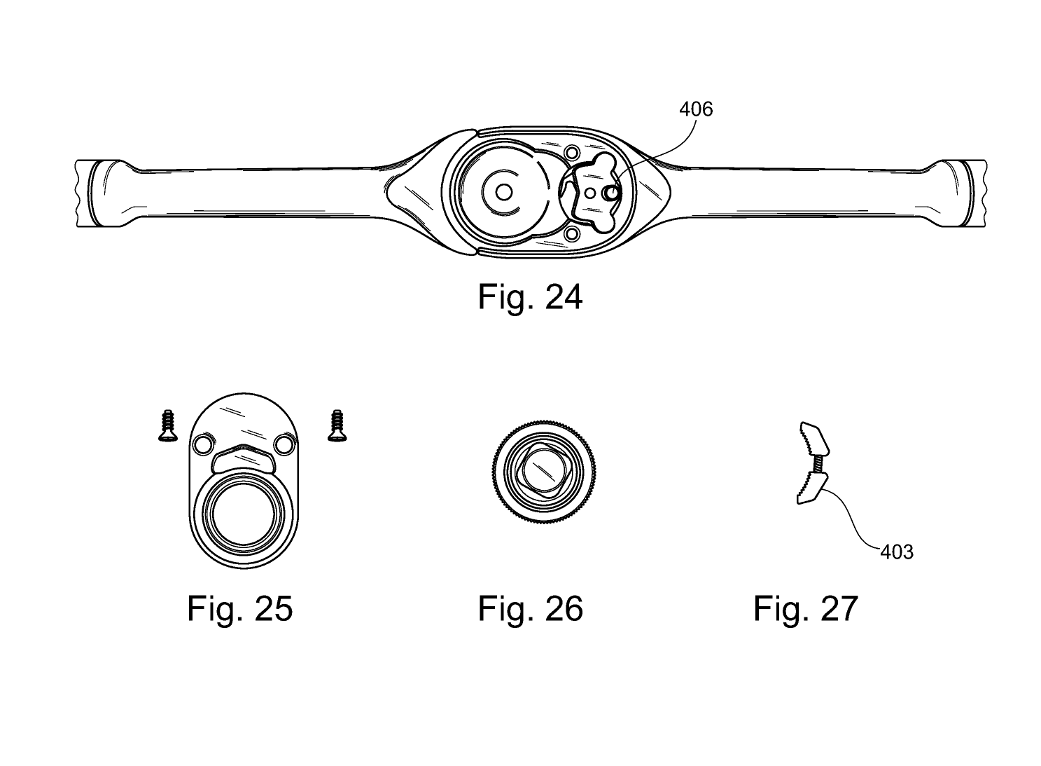

FIG. 24 shows center housing with a shifter spacer spring 406 installed upon a shifter.

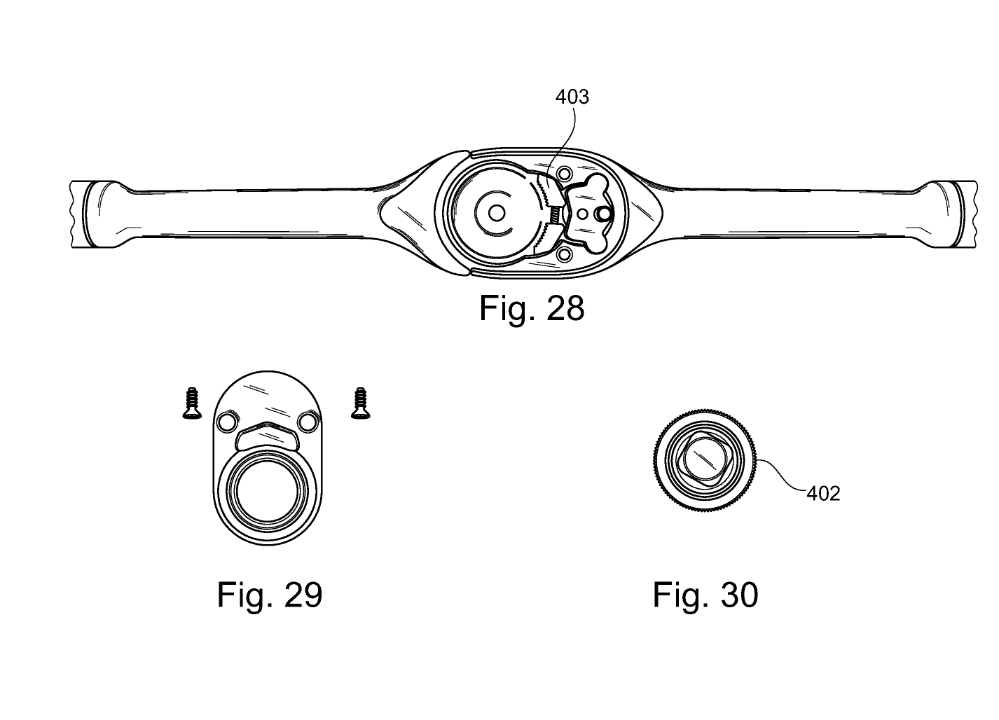

FIG. 28 shows a pawl installed into a center housing and adjacent to a shifter.

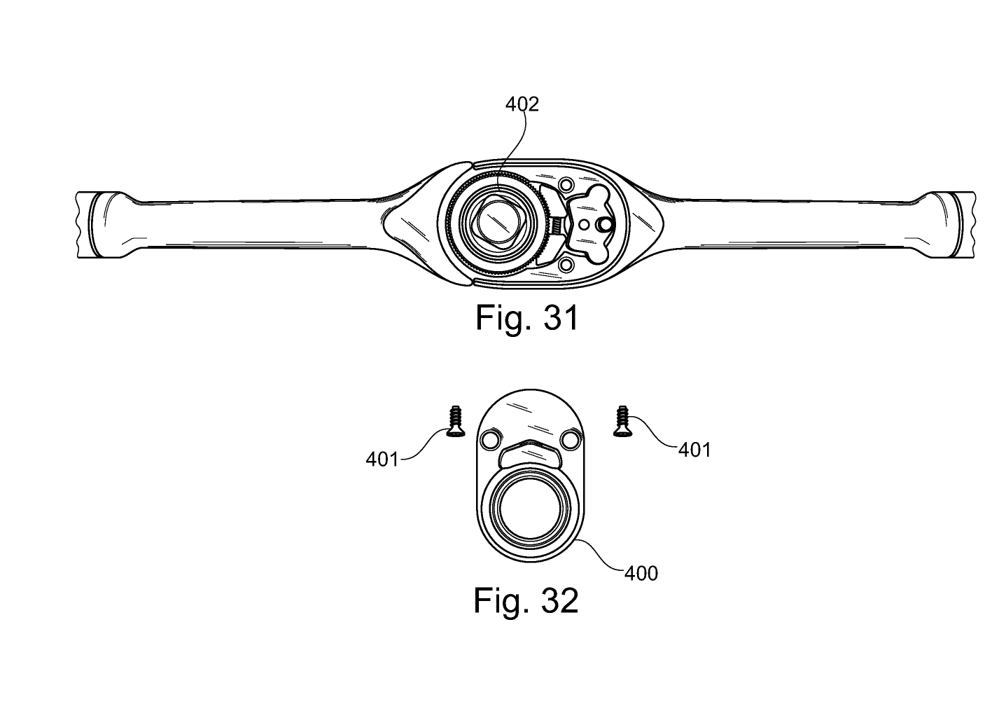

FIG. 31 shows a socket head 402 installed into a large void within the housing 300. The socket head is adjacent to a pawl, such that movement of the pawl by the shifter will determine the direction of torque applied by the socket head.

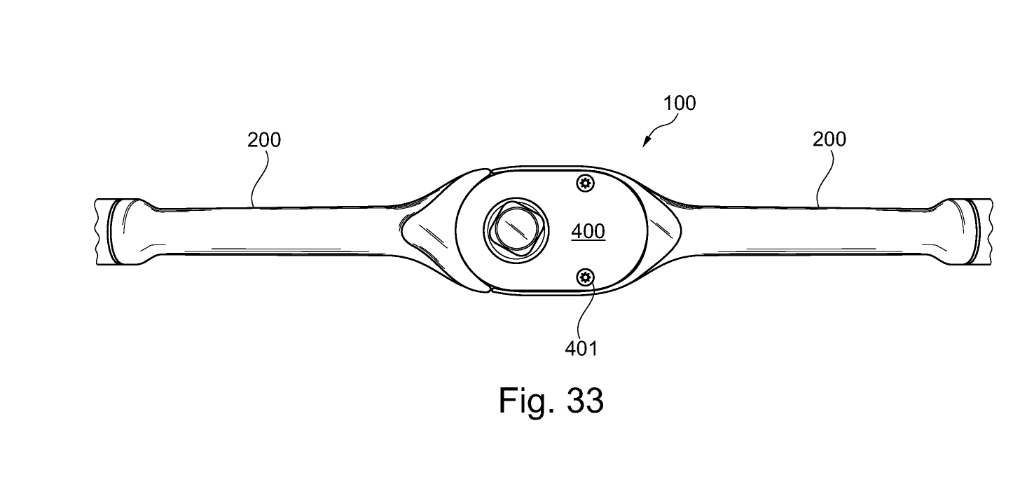

FIG. 33 presents a housing cover 400 attached and covering a center housing 300. Handles 200 are shown to be on either side of the center housing.

Items.

Embodiments of the invention include but are not limited to the following items. The terms used in the items and defined meanings of item terms are not limiting with respect to claims or claim terms.

Item 1. A dual handle socket ratchet hand tool, the tool comprising:

a) two handles 200;

b) a center housing 300, with one handle 200 attached to each side of the center housing 300;

c) the center housing 300, comprising a first void 301 being larger than a second void 302, with the second void being smaller than the first void;

d) a pawl 403 placed between the first and second voids;

e) a socket head 402 placed within the first void 301;

f) a shifter 404 placed between the socket head 402 and pawl;

g) the center housing 300 having a back side 303, with a shifter placed upon the backside of the housing 303 and in communication with shifter 404; and

h) the shifter 404 being in communication with the pawl 403, and the pawl in communication with the socket head, such that the direction of torque is influenced by the position of the pawl.

Item 2. The tool of item 1 wherein the socket head 402 is comprised of an outer hex head shape.

Item 3. The tool of item 1 wherein the socket head 402 is comprised of a square outer head shape.

Item 4. The tool of item 1 wherein the socket head 402 is comprised of a polygon outer head shape.

What is claimed is:

1. A dual handle socket ratchet hand tool, the tool comprising:
a) two handles;
b) a center housing, with one handle attached to each side of the center housing;
c) the center housing, comprising a first void being larger than a second void, with the second void being smaller than the first void;
d) a pawl placed between the first and second voids;
e) a socket head placed within the first void;
f) a shifter placed between the socket head and pawl;
g) the center housing having a back side, with a shifter placed upon the backside of the housing and in communication with shifter; and
h) the shifter being in communication with the pawl, and the pawl in communication with the socket head, such that the direction of torque is influenced by the position of the pawl.

2. The tool of claim 1 wherein the socket head is comprised of an outer hex head shape.

3. The tool of claim 1 wherein the socket head is comprised of a square outer head shape.

4. The tool of claim 1 wherein the socket head is comprised of a polygon outer head shape.
